(19) United States
(12) Patent Application Publication
(10) Pub. No.: US 2013/0239018 A1
(43) Pub. Date: Sep. 12, 2013

(54) GRAPHICAL DISPLAY RESPONSIVE TO VOICE INPUT

(71) Applicant: Geoffry A. Westphal, Evanston, IL (US)

(72) Inventor: Geoffry A. Westphal, Evanston, IL (US)

(73) Assignee: W.W. GRAINGER, INC., Lake Forest, IL (US)

(21) Appl. No.: 13/417,709

(22) Filed: Mar. 12, 2012

(51) Int. Cl. G06F 3/048; G10L 15/26

(52) U.S. Cl. 715/753; 704/235; 704/E15.043

(57) ABSTRACT

An embodiment of the present invention is directed to controlling a graphical display responsive to voice input. A voice input is received from a live telephone conversation between two or more parties. The voice input is then analyzed for the presence of a product model number. The product model number is then extracting from the voice input. The product model number is then displayed in a model number listing on the graphical display while the conversation is still ongoing.

### BACKGROUND

The telephone still plays an important part of business, despite the proliferation of the internet. Customers still use the telephone to place product orders and check the status of their orders, as well as to request product pricing and availability. Large business-to-business vendors experience tens of thousands of calls daily. During these calls, a lot of information is exchanged over the phone, i.e. verbally, including ship-to and bill-to addresses, account numbers, names of people, brands names of products, etc. there are numerous ways of referring to products, including by manufacturers' model numbers, competitor model numbers, part numbers, and vendor catalog numbers. These numbers can be purely numeric or alpha numeric. To further complicate matters, it is common during the order process to talk about several products and alternatives to those products, e.g. due to logistic challenges and product availability. Moreover, during technical support calls, a customer will often use model numbers when communicating with the vendor about technical matters.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

The following generally describes systems and methods for controlling a graphical display responsive to voice input. More particularly, systems and methods are described that a receive a voice input from a live telephone conversation between two or more parties. The voice input is then analyzed for the presence of a product model number. The product model number is then extracting from the voice input. The product model number is then displayed in a model number listing on the graphical display while the conversation is still ongoing.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 illustrates an exemplary operating environment for implementing embodiments;

FIG. 2 illustrates a system for controlling a graphical display responsive to voice input, in accordance with various embodiments of the present invention;

FIG. 3 illustrates a first screen of an example user interface of an embodiment;

FIG. 4 illustrates a second screen of an example user interface of an embodiment;

FIG. 5 is flowchart of a processes for controlling a graphical display responsive to voice input, in accordance with an embodiment;

FIG. 6 is flowchart of a processes for analyzing voice input for the presence of a product model number, in accordance with an embodiment.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the claims. Furthermore, in the detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions that follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

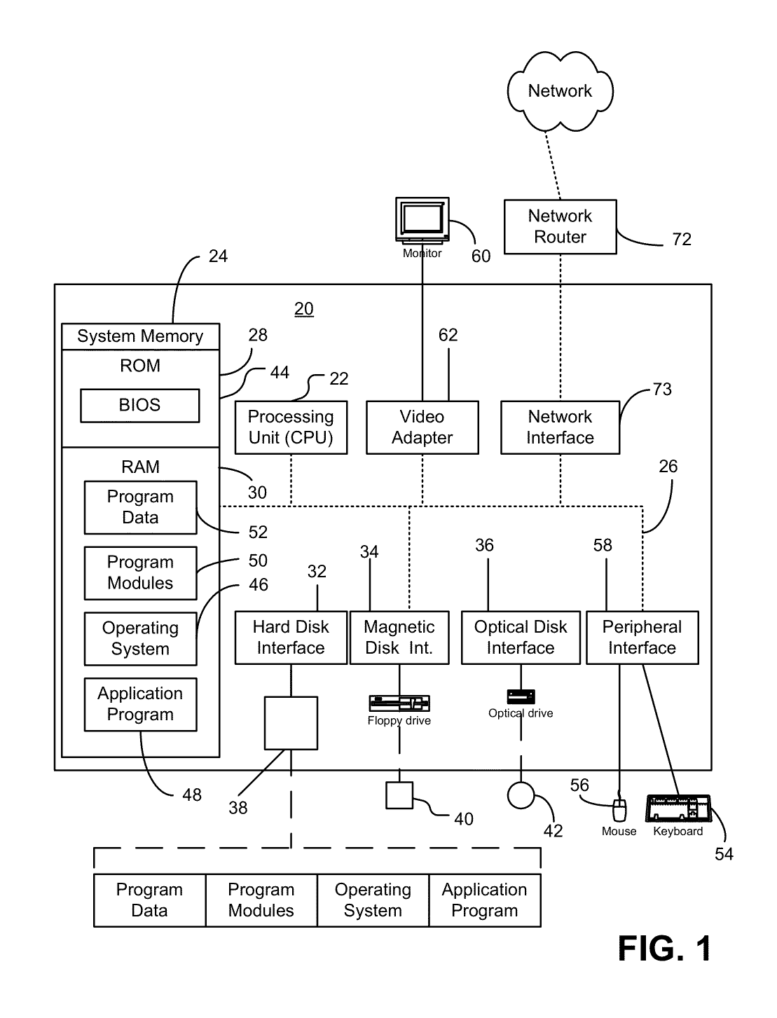

With reference to the figures, systems and methods are hereinafter described for controlling a graphical display responsive to voice input. While not intended to be limiting, the system and method will be described in the context of a plurality of processing devices linked via a network, such as a local area network or a wide area network, as illustrated in FIG. 1. In this regard, a processing device 20, illustrated in the exemplary form of a device having conventional computer components, is provided with executable instructions to, for example, provide a means for a user to access a remote processing device, such as a client, server, database, etc., via the network to, among other things, perform a search of a product model number database. Generally, the computer executable instructions reside in program modules which may include routines, programs, objects, components, data structures, etc. that perform particular tasks or implement particular abstract data types. Accordingly, those skilled in the art will appreciate that the processing device 20 may be embodied in any device having the ability to execute instructions such as, by way of example, a personal computer, mainframe computer, personal-digital assistant (“PDA”), cellular or smart telephone, tablet computer, or the like. Furthermore, while described and illustrated in the context of a single processing device 20, those skilled in the art will also appreciate that the various tasks described hereinafter may be practiced in a distributed or cloud-like environment having multiple processing devices linked via a local or wide-area network whereby the executable instructions may be associated with and/or executed by one or more processing devices.

For performing the various tasks in accordance with the executable instructions, the processing device 20 preferably includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD/BD ROM or other optical media. The drive interfaces and their associated non-transient, computer-readable media allow for the nonvolatile storage of computer readable instructions, data structures, program modules and other data for the processing device 20. Those skilled in the art will further appreciate that other types of non-transient, computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser, camera, picture editor, etc.), other program modules 50, and/or program data 52. Still further, computer-executable instructions may be downloaded to one or more of the computing devices as needed, for example, via a network connection.

A user may interact with the various application programs 48, etc. of the processing device, e.g., to enter commands and information into the processing device 20, through input devices such as a touch screen, keyboard 54 and/or a pointing device 56. While not illustrated, other input devices may include a microphone, a joystick, a game pad, a scanner, a camera, a gesture recognizing device, etc. These and other input devices would typically be connected to the processing unit 22 by means of an interface 58 which, in turn, would be coupled to the bus 26. Input devices may be connected to the processor 22 using interfaces such as, for example, a parallel port, game port, IEEE 1394, or a universal serial bus (USB). To view information from the processing device 20, a monitor 60 or other type of display device may also be connected to the bus 26 via an interface, such as a video adapter 62. In addition to the monitor 60, the processing device 20 may also include or otherwise be coupled to other peripheral output devices, not shown, such as speakers and printers.

The processing device 20 may also utilize logical connections to one or more remote processing devices. Communications between the processing device 20 and the remote processing devices may be exchanged via a further processing device, such as a network router 72 that is responsible for network routing. Communications with the network router 72 may be performed via a network interface component 73.

Generally speaking, various embodiments provide technology for controlling a graphical display which in turn facilitates a discussion between, for example, a customer and a customer service representative (CSR). More specifically, various embodiments provide technology whereby a live conversation (e.g. in-person, over the telephone, etc.) between the customer and the CSR is monitored for recitations of product model numbers. If one of the parties to the conversation recites a product model number, the spoken model number is automatically extracted to text and displayed on a graphical display associated with the CSR. The CSR may then interact with the graphical display to retrieve additional information associated with the extracted model number towards consummation of a sale of the associated product.

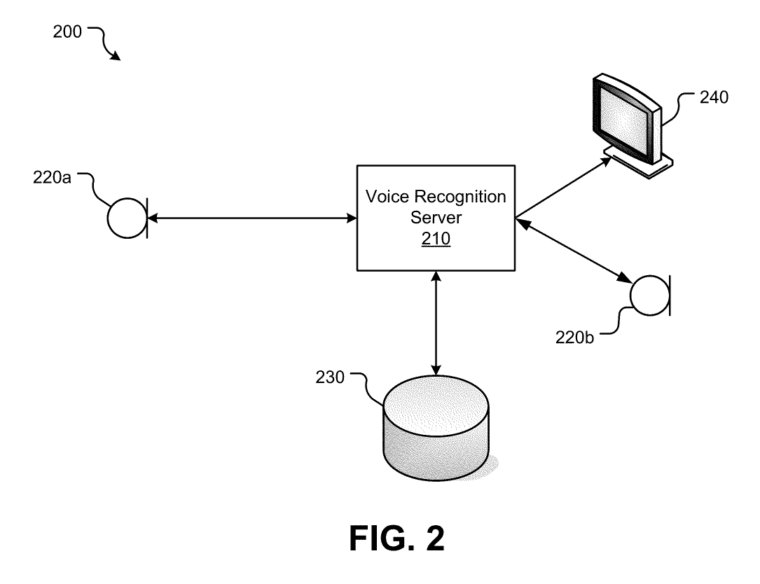

FIG. 2 illustrates a system 200 for controlling a graphical display, in accordance with various embodiments of the present invention. As illustrated, system 200 includes a voice recognition server 210 having an input coupled with one or more microphones 220. Although the illustrated embodiment depicts two microphones 220, it will be appreciated in light of the present disclosure that system 200 may alternatively use any number of microphones, including a single microphone (e.g. 220b) that is coupled with or integrated into voice recognition server 210. Voice recognition server 210 is also coupled with a graphical display, such as a computer monitor, a tablet display, or any other suitable display device known in the art. The voice recognition server 210 may also have an output coupled with one or more associated data repositories 240, e.g., storing a database of product information, etc. In this regard, while the voice recognition server 210 has been illustrated in the exemplary form of a computer, it will be appreciated that the voice recognition server 210 may, like processing device 20, be any type of device having processing capabilities. Again, it will be appreciated that the voice recognition server 210 need not be implemented as a single device but may be implemented in a manner such that the tasks performed by the voice recognition server 210 are distributed to a plurality of processing devices linked through a communication network, e.g., implemented in the cloud. Additionally, the voice recognition server 210 may have logical connections to other third party server systems via the network as needed and, via such connections, will be associated with data repositories that are associated with such other third party server systems.

For performing tasks, the voice recognition server 210 may include many or all of the elements described above relative to the processing device 20. By way of further example, the voice recognition server 210 includes executable instructions stored on a non-transient memory device for, among other things, analyzing voice input, searching database 230, etc. Thus, within a networked environment, e.g., the Internet, World Wide Web, LAN, or other similar type of wired or wireless network, it will be appreciated that program modules depicted relative to the processing device 20, or portions thereof, may be stored in the memory storage device(s) of the voice recognition server 210 .

Generally speaking, voice recognition server 210 is operable to monitor a live conversation received via microphone(s) 220 between, for example, a customer and a CSR for occurrences of spoken model numbers. In the case where system 200 includes only a single microphone 220, the microphone may be coupled with or integrated into, for example, a point-of-sale register. In cases where the system 200 includes multiple microphones 220, the microphones may be coupled with or integrated into one or more computers or a telephony devices that transmit voice signals via “plain old telephone service” (POTS), a cellular telephone network, Voice over IP (VoIP), or any combination thereof. As such, the microphones may be remote from each other.

The voice recognition server 210 may monitor a live conversation for occurrences of spoken model numbers, for example, by monitoring the conversation for occurrences of spoken letters and/or numbers and then comparing each such occurrence with known product model numbers stored in database 230. When a match is found, the spoken model number is extracted to text and added to a product model number list, or “stack,” that is displayed on graphical display 240. Techniques for voice recognition and converting voice to text as well known and therefore not discussed at length here, so as not to unnecessarily obscure aspects of the present invention.

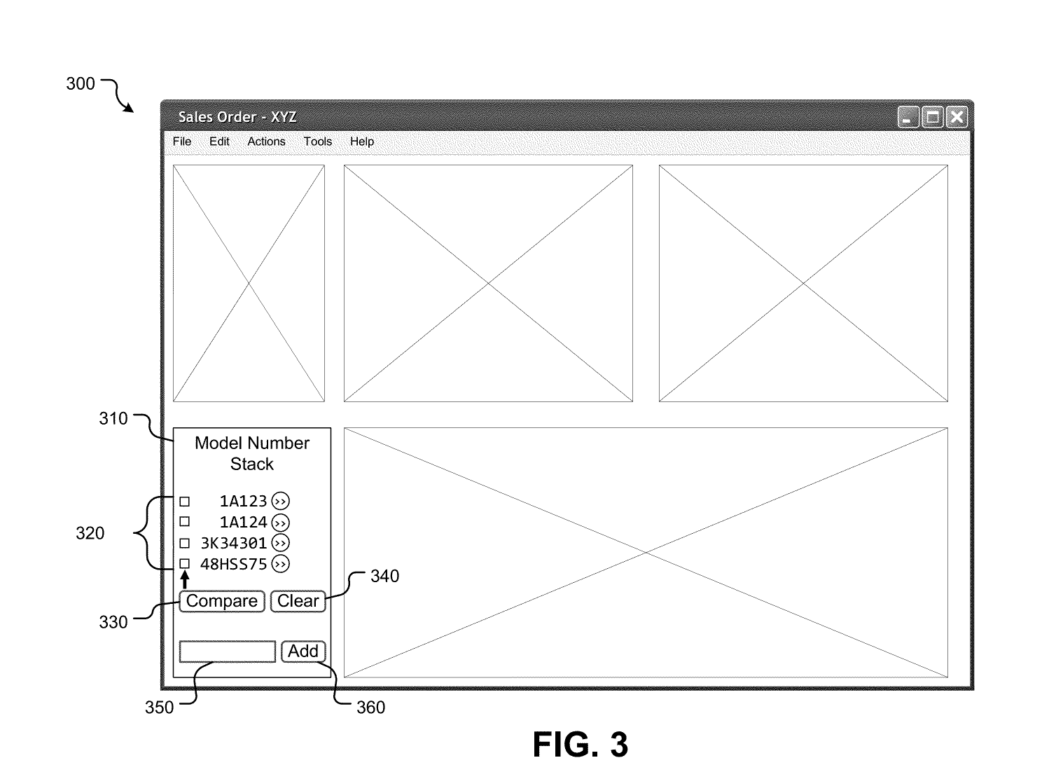

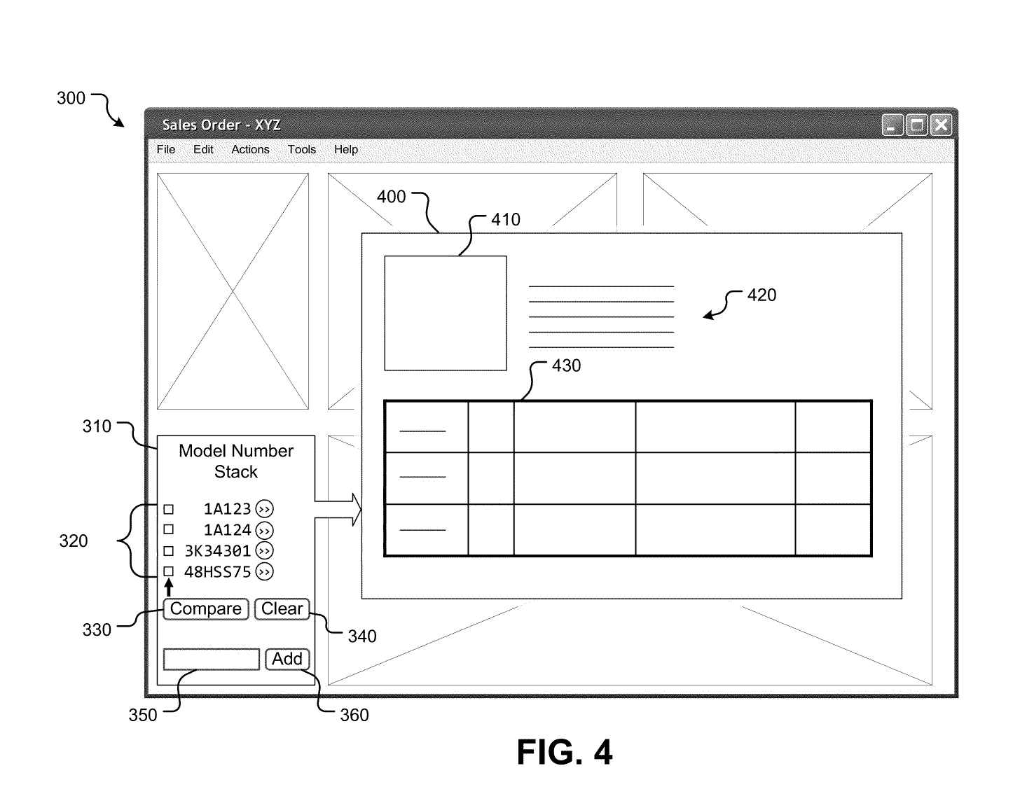

FIGS. 3-4 illustrate various screens of an example user interface 300, in accordance with an embodiment. As shown in FIG. 3, the user interface 300 includes a model number stack section 310, which in turn includes a model number listing 320. As the voice recognition server 210 detects spoken model numbers, the detected model numbers are added to listing 320.

As model numbers accumulate in the listing 320, the a user can perform operations on them. For example, a CSR using the illustrated embodiment could delete a number, by checking the box next to the number and clicking the Clear button 340. A CSR may also manually add a number by typing it into text box 350 and clicking the Add button 360. Additionally, when multiple model numbers are in the listing 320, several model numbers could be selected for the comparison of specifications, e.g. by checking the boxes next to the appropriate numbers and clicking the Compare button 330. In response to such a request for a comparison, a table containing product information concerning the products associated with the selected model numbers may be displayed on graphical display 240.

In one embodiment, a user may request to see additional information regarding the product associated with a particular product model number. To enable this ability, each of the model numbers displayed in the listing 320 may have associated therewith a user-selectable graphical user interface (GUI) element, such as a hyperlink, a button or the like, which, when selected, causes the product information pop-up window 400 shown in FIG. 4 to be displayed. The pop-up window 400 may include, but is not limited to, a picture 410 of the associated product, a series of links 420 related to the product, and a product data listing 430. The links 420 could be links to contextual information relating to the product, including but not limited to videos, third party vendor websites, product manuals and other product documentation and comments and reviews. The product data listing 430 may contain information including, but not limited to, availability of the product, a brand name of the product and/or a price of the product.

The foregoing functions for model numbers being populated in the listing 320 could be performed automatically. For example, customer-specific pricing could be calculated and displayed; system availability could be checked and displayed; and images, descriptions, videos, and additional reference information could be retrieved corresponding to each model number in the listing 320.

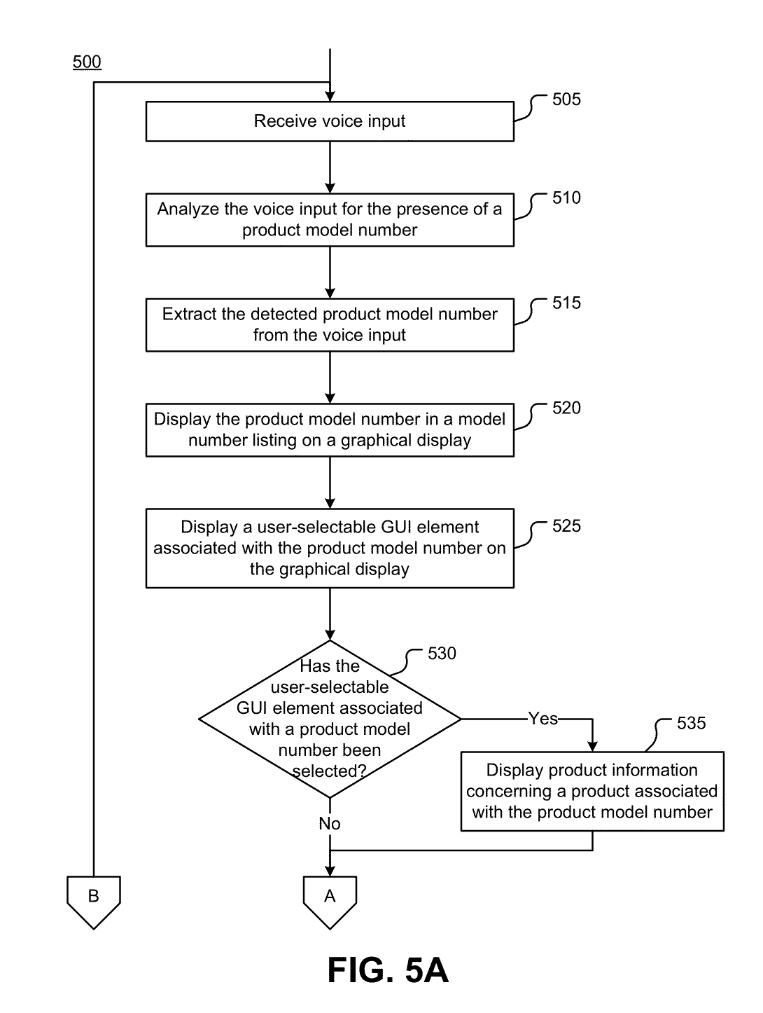

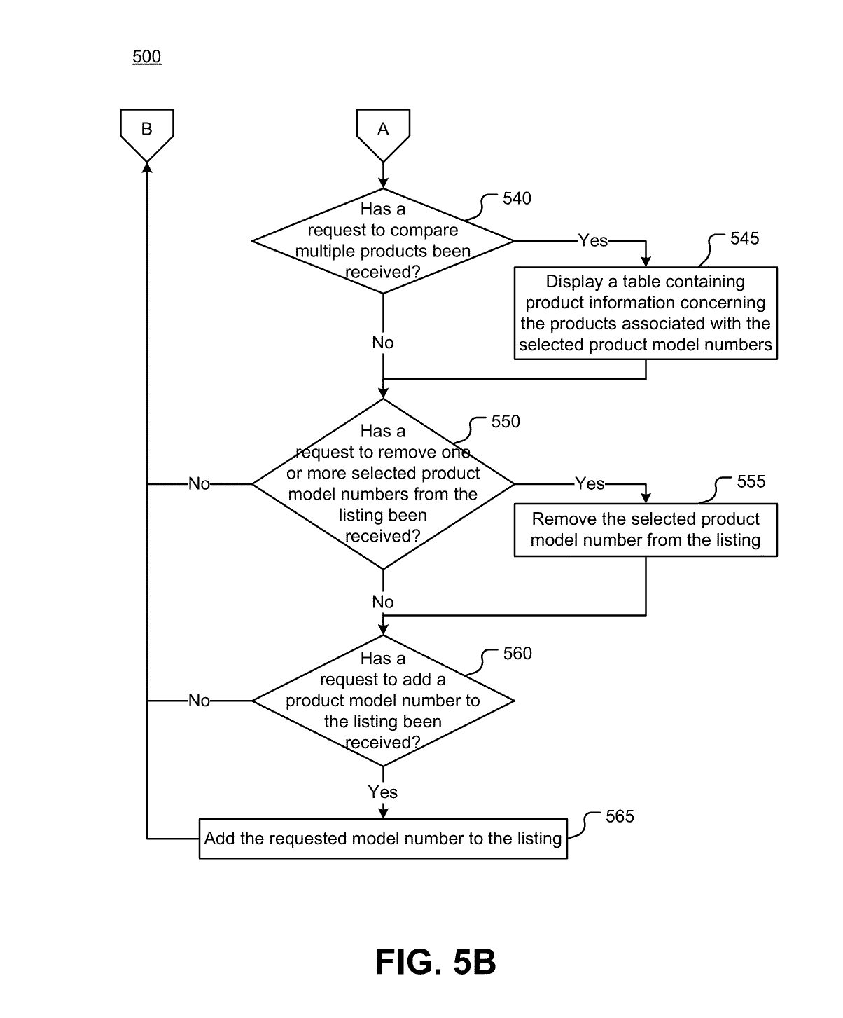

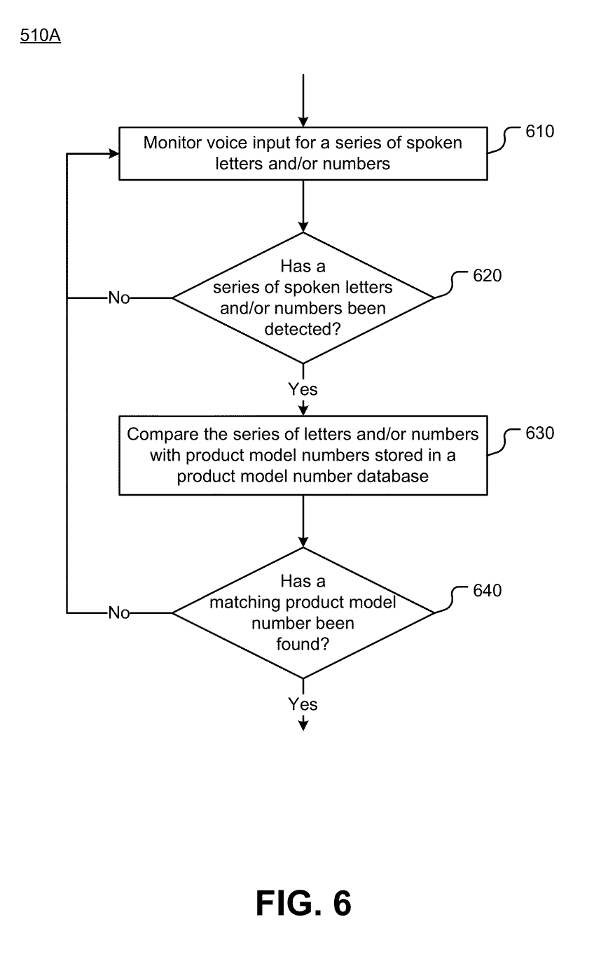

The following discussion sets forth in detail the operation of present technology for searching a product model number database. With reference to FIGS. 5-6, flowcharts 500 and 510A each illustrate example steps used by various embodiments of the present technology for a voice recognition server 210. Flowcharts 500 and 510A include processes that, in various embodiments, are carried out by a processor under the control of non-transient, computer-readable and computer-executable instructions. The computer-readable and computer-executable instructions may reside, for example, in data storage features such as storage devices 24, 38, 40 and/or 42 of FIG. 1. Although specific operations are disclosed in flowcharts 500 and 510A, such operations are examples. That is, embodiments are well suited to performing various other operations or variations of the operations recited in flowcharts 500 and 510A. It is appreciated that the operations in flowcharts 500 and 510A may be performed in an order different than presented, including in parallel, and that not all of the operations in flowcharts 500 and 510A may be performed. Where helpful for the purposes of illustration and not for limitation, FIGS. 5-6 will be described with reference to FIGS. 1 and 2, which illustrate a hypothetical situation in which embodiments may be implemented.

Flowchart 500 beings at block 505, where a voice input is received. The voice input may be received via one or more microphones 220, which may in turn be coupled to or comprised within a computer 20 or telephony device. At block 510, the voice input is analyzed for the presence of a product model number. It should be appreciated that this may be achieved in a number of ways. For example, FIG. 6 illustrates a process 510A for analyzing voice input for the presence of a model number, in accordance with an embodiment of the present invention. Process 510A begins at block 610, where the voice input is monitored for a series of spoken letters and/or numbers—the “signature” of a product model number. At block 620 a determination is made as to whether a series of spoken letters and/or numbers has been detected. If one has not, then process 510A returns to block 610. If one has been found, then process 510A proceeds to block 630, where the detected series of letters and/or numbers is compared with known product model numbers stored in a database 230. This may be achieved, for example, by submitting a query based on the series of letters and/or numbers to the database 230. At block 640, a determination is made as to whether a matching product model number has been found in the database 230. If not, process 510A returns to block 610. If a match is found, process 510A exits—that is, it proceeds to step 515 in FIG. 5A. Notably, and as will become more apparent from the following discussion, unless a series of letters and/or numbers is detected by the voice recognition server 210 and that series is found to match a known product number (i.e. stored in a database 230), various embodiments of the present invention do not display other converted text from the monitored conversation on display 240, so as not to confuse a CSR by displaying meaningless “noise.”

With reference again to FIG. 5, process 500 resumes at block 515, where a detected model number is extracted from the voice input into text. The extracted model number is then displayed on a graphical display 240 (block 520), for example, in a an item stack 310, or listing 320, of model numbers. At block 525, a user-selectable GUI element, such as a link, a button or the like, associated with the product model number is displayed on the graphical display 240.

Once a detected model number has been extracted and displayed together with the appropriate GUI elements, various functions may be performed on the model number and/or the listing 320 of which it is a part. For instance, at block 530, a determination is made as to whether the user-selectable GUI element associated with a product model number has been selected. If not, then process 500 simply proceeds to block 540. If, however, a selection has been made, process 500 then proceeds to block 535, where product information concerning the product associated with the selected model number is displayed. Such product information may include, but is not limited to, an image of the product, links relating to the product, availability of the product, a brand name of the product and/or a price of the product. The product information may be displayed in a pop-up window, such as window 400 depicted in FIG. 4, as a stand-alone screen, or in any other manner known to one of ordinary skill in the art.

A user may also be given the option of comparing multiple products corresponding to model numbers displayed in the listing. For example, at block 540, a determination is made as to whether a request to compare multiple products has been received. If not, then process 500 proceeds to block 550. If such a request has been received, then process 500 proceeds to block 545, where a table containing product information (such as the product information described above) concerning the selected products is displayed. Preferably, this information is displayed in a side-by-side format.

One or more model numbers may also be manually removed from or added to the listing 320. For example, at block 550, a determination is made as to whether a request to remove one or more model numbers from the listing 320 has been received. Such a request may be submitted, for example, by selecting the checkboxes next to the desired model numbers and then activating a Clear button 340. If such a request is received, process 500 proceeds to block 555, where the selected model number(s) is/are removed from the listing 320. If not, then process 500 proceeds to block 560. Similarly, at block 560, a determination is made as to whether a request to add a model number to the listing has been received. Such a request may be submitted, for example, by entering the desired model number into a text box 350 and then activating an Add button 360. If such a request is received, process 500 proceeds to block 565, where the requested model number is added to the listing 320. If not, then process 500 returns to block 505 and continues as described above.

Thus, various embodiments of the present invention provide for automatic, near real-time, population of a model number stack on a graphical display based on model numbers recited during a live conversation. This automatic population of the stack frees up, for example, a CSR from writing down model numbers and allows her to focus on the business task, rather than asking for model numbers to be repeated. This also similarly expedites the product ordering process because a CSR is no longer forced to key the model numbers into the system at all.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer-readable medium embodied in a non-transient, physical memory device having stored thereon computer executable instructions for controlling a graphical display, the instructions performing steps comprising:
receiving a voice input from a live telephone conversation between two or more parties;
analyzing the voice input for the presence of a product model number;
extracting the product model number from the voice input; and
displaying the product model number in a model number listing on the graphical display while the conversation is still ongoing.

2. The computer-readable medium as recited in claim 1, wherein the instructions further comprise:
displaying, on the graphical display, product information concerning a product associated with the product model number.

3. The computer-readable medium as recited in claim 2, wherein the product information comprises one or more of availability of the product, a brand name of the product, a price of the product and a product image associated with the product.

4. The computer-readable medium as recited in claim 1, wherein displaying the product model number in the model number listing on the graphical display comprises displaying the product model number together with a user-selectable graphical user interface element associated with the displayed product model number.

5. The computer-readable medium as recited in claim 4, wherein the user-selectable graphical user interface element comprises one or more of a hyperlink and a button.

6. The computer-readable medium as recited in claim 4, wherein the instructions further comprise:
detecting a selection of the user-selectable graphical user interface element; and
displaying, on the graphical display, product information concerning a product associated with the product model number.

7. The computer-readable medium as recited in claim 6, wherein the product information comprises one or more of availability of the product, a brand name of the product, a price of the product and a product image associated with the product.

8. A computer-readable medium embodied in a non-transient, physical memory device having stored thereon computer executable instructions for controlling a graphical display associated with a first party, the instructions performing steps comprising:
receiving a voice input during a live telephone conversation between the first party and the second party;
analyzing the voice input for the presence of a product model number;
extracting the product model number from the voice input;
displaying the product model number in a model number listing on the graphical display associated with the first party while the conversation is still ongoing.

9. The computer-readable medium as recited in claim 8, wherein the instructions further comprise:
displaying, on the graphical display associated with the first party, product information concerning a product associated with the product model number.

10. The computer-readable medium as recited in claim 9, wherein the product information comprises one or more of availability of the product, a brand name of the product, a price of the product and a product image associated with the product.

11. The computer-readable medium as recited in claim 8, wherein displaying the product model number in the model number listing on the graphical display comprises displaying the product model number together with a user-selectable graphical user interface element associated with the displayed product model number.

12. The computer-readable medium as recited in claim 11, wherein the user-selectable graphical user interface element comprises one or more of a hyperlink and a button.

13. The computer-readable medium as recited in claim 11, wherein the instructions further comprise:
detecting a selection of the user-selectable graphical user interface element; and
displaying, on the graphical display associated with the first party, product information concerning a product associated with the product model number.

14. The computer-readable medium as recited in claim 13, wherein the product information comprises one or more of availability of the product, a brand name of the product, a price of the product and a product image associated with the product.

15. An apparatus for controlling a graphical display device, comprising:
a memory;
an input for receiving a voice input from a live telephone conversation between two or more parties;
an output for providing control signals to the graphical display device;
a processor for analyzing the voice input for the presence of a product model number, extracting the product model number from the voice input, and causing the graphical display device to display the product model number in a model number listing while the conversation is still ongoing.

16. The apparatus as recited in claim 15, wherein the processor causes the graphical display device to display product information concerning a product associated with the product model number.

17. The apparatus as recited in claim 16, wherein the product information comprises one or more of availability of the product, a brand name of the product, a price of the product and a product image associated with the product.

18. The apparatus as recited in claim 15, wherein the processor causes the graphical display device to display the product model number together with a user-selectable graphical user interface element associated with the displayed product model number.

19. The apparatus as recited in claim 18, wherein the user-selectable graphical user interface element comprises one or more of a hyperlink and a button.

20. The apparatus as recited in claim 18, wherein the processor detects a selection of the user-selectable graphical user interface element and causes the graphical display device to display product information concerning a product associated with the product model number.

21. The apparatus as recited in claim 20, wherein the product information comprises one or more of availability of the product, a brand name of the product, a price of the product and a product image associated with the product.

22. A system for providing a graphical display responsive to voice input from a live telephone conversation between two or more parties, comprising:
a graphical display device;
a database of product information including product model numbers;
a voice recognition apparatus coupled with the graphical display device and the database, the voice recognition apparatus adapted to compare the voice input with the product model numbers in the database to determine the presence of a product model number in the voice input, extract the product model number from the voice input, and cause the graphical display device to display the product model number in a model number listing while the conversation is still ongoing.
